(19) United States
(12) Patent Application Publication
(10) Pub. No.: US 2005/0149881 A1
(43) Pub. Date: Jul. 7, 2005

(54) Dynamically configurable human-machine interface

(75) Inventors: Lorraine Proulx, Kanata (CA); Dominique Trudeau, Orleans (CA); Sasa Nijemcevic, Nepean (CA)

Correspondence Address: MARKS & CLERK, P.O. BOX 957, STATION B, OTTAWA, ON, K1P 5S7, CA

(73) Assignee: Alcatel Canada Inc., Kanata (CA)

(21) Appl. No.: 11/068,827

(22) Filed: Mar. 2, 2005

Related U.S. Application Data
(62) Division of application No. 10/072,909, filed on Feb. 12, 2002.

(30) Foreign Application Priority Data
Dec. 19, 2001 (CA) 2,365501

(51) Int. Cl. G06F 3/00; G06F 15/173

(52) U.S. Cl. 715/853; 715/854; 715/762; 715/765; 709/223

(57) ABSTRACT

A framework is presented to provide support for dynamically configuring a human-machine interface in a network management and service provisioning environment. The framework implements a file parser, methods of accessing a managed object server to interact with instances of managed data network entity objects, a multitude of view panel components and a command interpreter. A multitude of run-time loadable descriptor files are provided to specify the functionality of view panel instances used by an analyst manipulate information in interacting with the network management and service provisioning environment. The parser is used to load descriptor files and instantiate view panels on demand. Advantages are derived from a separation between network management and service provisioning software application coded functionality and the specification of the human-machine interface presented to the analyst, providing improved development, maintenance and deployment of network management and service provisioning solutions.

### RELATED APPLICATIONS

This application is a division of application Ser. No. 10/072,909, filed Feb. 12, 2002.

### FIELD OF THE INVENTION

The invention relates to network management and service provisioning, and in particular to methods of providing a dynamically configurable network management and service provisioning solution.

### BACKGROUND OF THE INVENTION

In the field of data network management, data transport networks are made up of a collection of managed data transport equipment. Data services are provisioned over the managed data transport equipment.

In a competitive market place, due to a recent explosive technological development, the network management and service provisioning task is complicated by many factors including: multiple data network equipment vendors having multiple approaches in implementing the data network equipment; a multitude of data transport technologies, with each vendor specializing in a sub-group of the multitude of data transport technologies; a multitude of network management and service provisioning protocols, with each vendor implementing only a sub-group of the multitude of network management and service provisioning protocols; a multitude of auxiliary network management and service provisioning equipment employing yet another multitude of network management and service provisioning technologies; etc.

Data transport equipment includes, but is not limited to: data switching equipment, routers, bridges, access nodes providing a multiplexing function, Remote Access Servers (RAS), distribution nodes providing a demultiplexing function, Customer Premise Equipment (CPE), etc. with next generation data transport equipment in development.

With regards to data network equipment, for example data switching nodes schematically shown in FIG. 1, a vendor may chose to implement an integral device 110 having a data switching processor and a group of ports 112, while another vendor may chose a customizable implementation of a data switching node 120 including: a switching fabric, an equipment rack divided into shelves, each shelf 122 having slot connectors for connection with interface cards, each interface card 124 having at least one port 112. Although conceptually the two the data switching nodes 110 and 120 provide the same data switching function, each implementation is adapted for a different environment: the former data switching node 110 is more adapted to enterprise solutions as a private data network node, perhaps further adapted to enable access to public data services; while the latter data switching node 120 is better adapted for high data throughput in the core of public data transport networks. Typically the former (110) implements a small number of data transport protocols while for the latter (120), data transport protocols are implemented on interface cards 124 and/or ports 112—providing for a flexible deployment thereof. All data network equipment is subject to design choices which are bound to be different from vendor to vendor.

Data transport technologies include: electrical transmission of data via copper pairs, coaxial cable, etc: optical transmission of data via optical cables; free space optical interconnects, etc.; wireless transmission of data via radio modems, microwave links, wireless Local Area Networking (LAN), etc.; with next generation data transport technologies under development.

Data transport protocols used to convey data between data transport equipment includes: Internet Protocol (IP), Ethernet technologies, Token-Ring technologies, Fiber Distributed Data Interface (FDDI), Asynchronous Transmission Mode (ATM), Synchronous Optical NETwork (SONET) transmission protocol, Frame Relay (FR), X-25, Time Division Multiplexing (TDM) transmission protocol, Packet-Over-SONET (POS), Multi-Protocol Label Switching (MPLS), etc. with next generation data transport protocols in development.

The physical data network equipment alluded to above is part of larger body of managed data network entities enabling the provision of data services. The data network entities also include, but are not limited to: virtual routers, logical ports, logical interfaces, end-to-end data links, paths, virtual circuits, virtual paths, etc.

Network management and service provisioning enabling technologies include, but are not limited to protocols: Simple Network Management Protocol (SNMP), Common Management Information Protocol (CMIP) etc.; as well as devices: special function servers, centralized databases, distributed databases, relational databases, directories, network management systems, etc. with next generation devices and technologies under development.

Network management and service provisioning solutions include Network Management Systems (NMS) 130 enabled via special purpose software applications coded to configure and control the above mentioned data network entities. Such software applications include, but are not limited to: inventory reporting, configuration management, statistics gathering, performance reporting, fault management, network surveillance, service provisioning, billing & accounting, security enforcement, etc.

It is a daunting task to provide network management and service provisioning solutions taking into account the permutations and combinations of the elements presented above. Prior art approaches to providing network management and service provisioning solutions include the coding of hundreds of software applications with knowledge of hundreds of data networking entities using tens of data transmission and network management protocols. Some prior art solutions attempt to code all-encompassing large monolithic network management and service provisioning software applications.

Coding, deploying, maintaining, and extending such software applications for network management and service provisioning has been and continues to be an enormous undertaking as well as an extremely complex procedure. Such software applications require a large number of man-hours to create, frequently are delivered with numerous problems, and are difficult to modify and/ or support. The difficulty in creating and supporting large applications is primarily due to the inability of existing software development paradigms to provide a simplification of the software development process. In accordance with current coding paradigms, the complexity of the software applications has been shown to increase as an exponential function of the number of different operations that are expected to be performed. Large programming efforts suffer in terms of reasonable performance, reliability, cost of development, and reasonable development cycles.

Object Oriented Programming (OOP) attempts to improve productivity whenever a problem can be simplified by decomposing it into a set of black-box objects. Object oriented programming depends heavily upon the benefits of data hiding, inheritance, and polymorphism to simplify software design. If a network management and service provisioning solution cannot be subdivided into objects, object oriented programming does not offer significant productivity improvements. Moreover, heavy reliance on object oriented programming to achieve compact code intending to reduce the size of software applications and perhaps development time, suffers from deeply nested function calls which creates a processing overhead leading to inefficient code. Deep nesting of function calls obscures the implementation paradigms used; thereby negatively impacting code debugging, code maintenance, and further development thereof.

Of special interest to the description herein is human-machine interface programming for information display to analysts interacting with NMS systems 130. Every data network entity has operational parameters associated therewith. Associations between data network entities are also made to enable: service provisioning (signaling, data transport, billing, etc.), providing redundancy (equipment, transport, bandwidth, etc.) as well as providing network management related data transport (network status updates, alarms, etc.) The amount of configuration and/or surveillance information associated with even the simplest of managed data transport networks tends to be very large. The information is typically divided up and presented to the analyst selectively in accordance with a context of network management and service provisioning. The selected information is presented to the analyst for visual inspection typically using view panels.

Object oriented programming techniques are used to implement very basic displayable elements known as widgets. Widgets include: icons, pull-down menus, buttons, selection boxes, progress indicators, on-off checkmarks, scroll bars, window frames, window manipulators, toggle buttons, sliders, tabs, and many other displayable elements for displaying information and for inviting, accepting, and responding to actions performed by an analyst.

Prior art efforts including: Preside™ by Nortel Networks Corp., IP Manager™ by Cisco Systems Inc., OneVision Management System™ by Lucent Technologies Inc., NetProvision Activator by Syndesis Limited, Resolve 2.1 by Orchestream Holdings Plc., and others, capture the: properties, associations, relationships, functionality and management of data network entities, as well as methods of interaction therewith in providing network management and service provisioning solutions into large monolithic software applications.

These efforts are all laudable, but at the same time, these solutions include hard-coded human-machine interfaces making it difficult to develop, extend and/or modify as necessary to add support for newly developed data network entities, new data transport protocols, new network management and service provisioning technologies, new contexts of network management and service provisioning etc. Further these solutions include hard-coded rules pertaining to valid actions that can be performed on data network entities as well as hard-coded rules pertaining to valid value ranges for each operational parameter thereof. The rules form part of what is know in the art as domain logic.

The productivity of the development and maintenance of such current complex software applications for network management and service provisioning suffers. In particular, view panels providing selective display of information have to be coded anew, the whole software application needs to be re-compiled and re-deployed to provide support for additional and/or updated data network entities. There is always a risk of causing errors in existing code when dealing with such large software applications thereby requiring extensive regression testing to verify the integrity of the existing code.

Other prior art network management and service provisioning solutions include the use of element management software. Element management software typically provides command line access to configuration of operational parameters. Element management software is typically provided by equipment vendors to enable configuration of specific data network equipment sold. Such attempts suffer from the use of a large number of element management software applications, an inconsistent human-machine interface and a lack of a data network wide view of the managed data network entities in providing network management and service provisioning solutions.

There therefore is a need to devise improved methods of software application code development and maintenance taking into account the above mentioned complexities.

### SUMMARY OF THE INVENTION

In accordance with an aspect of the invention, a graphical user interface framework is presented. The framework implements: at least one generic view panel component, a file parser, and machine logic. The framework makes use of at least one view panel descriptor file including information specifying the configuration of the at least one generic view panel component. The framework uses the parser to load the at least one descriptor file at run-time. The machine logic selectively configures the at least one generic view panel component in accordance with the specification detailed in the at least one descriptor file to display at least one view panel instance on a display interface. The use of the at least one generic view panel component and the run-time loading of the at least one descriptor file by the framework for run-time configuration thereof provides for a dynamic configuration of the display interface.

In accordance with another aspect of the invention, the framework further makes use of a command interpreter processing received commands in selectively configuring the at least one generic view panel.

In accordance with a further aspect of the invention, the framework further includes a registration facility registering at least one application module. The at least one application module interoperates with the machine logic in selectively configuring the at least one generic view panel component.

In accordance with a further aspect of the invention, a method of configuring a human-machine interface is provided. The method comprises a sequence of steps. An interaction context requiring a view panel to be displayed is determined. A descriptor file associated with the interaction context is selected to configure an instance of the view panel component prior to displaying the view panel. The run-time configuration of view panel components provides for a dynamic configuration of the human-machine interface.

In accordance with a further aspect of the invention, the method includes further steps in which the determination of the interaction context is determined from particulars of at least one command received by a framework implementing the method. The particulars of the at least one command are extracted using a command interpreter. The particulars of the received command may be made available to application modules registered with the framework; and at least one application module determines the interaction context.

In accordance with yet another aspect of the invention, the view panel instance may include a combination of view panel components.

A plurality of run-time loadable descriptor files are typically used to specify the functionality, look-and-feel of view panel instances presented on a human-machine interface used by an analyst to manipulate information. Instances of view panels created on demand include but are not limited to: list display, list filtering, tree display, parameter inspection, entity creation, entity configuration forms, etc.

Advantages are derived from a separation between network management and service provisioning software application coded functionality and the specification of the interface presented to the analyst. The separation also provides for an efficient development, maintenance and deployment of the network management and service provisioning solution. The modularity provided results in relaxed dependencies among source files, among development efforts to enable a faster parallel development. A simplification of the development of network management and service provisioning solutions is achieved while reducing requirements for regression testing.

### BRIEF DESCRIPTION OF THE DRAWINGS

The features and advantages of the invention will become more apparent from the following detailed description of the preferred embodiments with reference to the attached diagrams wherein:

FIG. 1 is a schematic diagram showing data network elements implementing connected data transport networks;

FIG. 2 is a schematic diagram showing elements implementing a network management and service provisioning solution in accordance with a preferred embodiment of the invention;

FIG. 3 is a schematic diagram showing a managed entity object hierarchy used in providing the network management and service provisioning solution in accordance with the preferred embodiment of the invention;

FIG. 4 is a schematic diagram showing an managed entity containment hierarchy used in providing the network management and service provisioning solution in accordance with the preferred embodiment of the invention;

FIG. 5 is a schematic diagram showing an exemplary human-machine interface associated with a software application, in accordance with an embodiment of the invention, participating in a network management and service provisioning solution;

FIG. 6 is a schematic diagram showing, in accordance with an exemplary embodiment of the invention, associations of data entities implementing a software component enabling a dynamically configurable human-machine interface;

FIG. 7 is a schematic diagram showing, in accordance with an exemplary implementation of the invention, a dynamically configurable view panel in support of a dynamically configurable human-machine interface;

FIG: 8 is another schematic diagram showing, in accordance with an exemplary embodiment of the invention, associations of data entities implementing another software component enabling a dynamically configurable human-machine interface; and

FIG. 9 is another schematic diagram showing, in accordance with an exemplary implementation of the invention, another dynamically configurable view panel in support of a dynamically configurable human-machine interface.

It will be noted that in the attached diagrams like features bear similar labels.

### DETAILED DESCRIPTION OF THE EMBODIMENTS

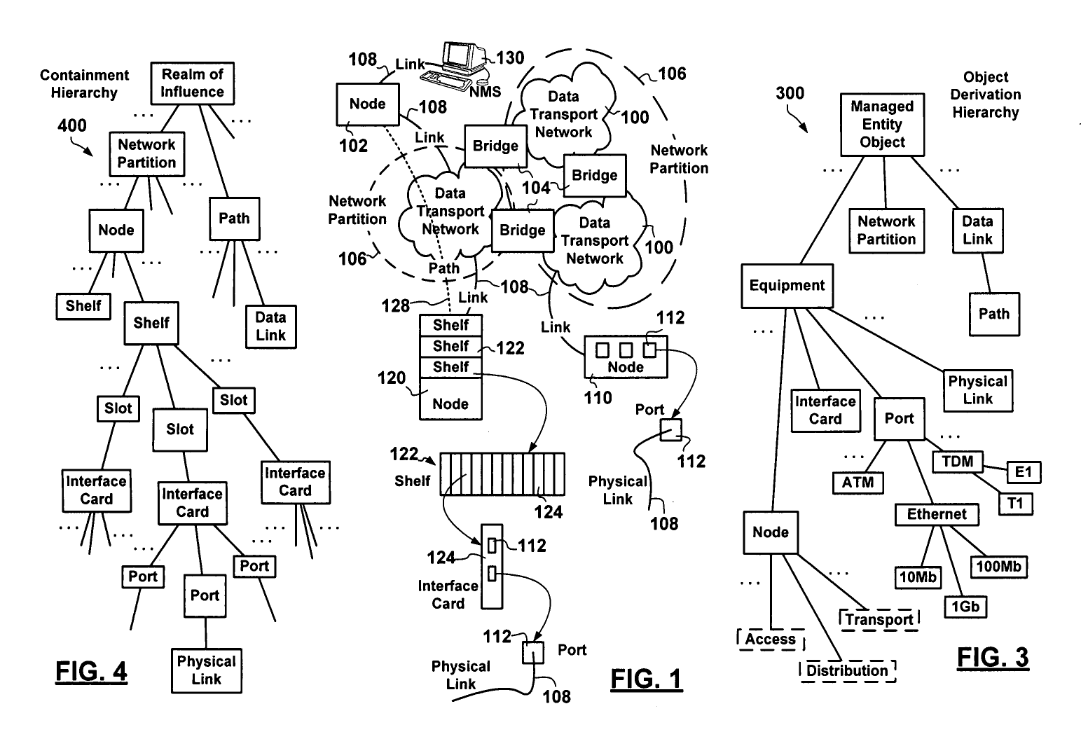

FIG. 1 is a schematic diagram showing data network elements implementing connected data transport networks.

Data network nodes 102, 110, 120 are physically interconnected in the data transport network 100 via physical links 108. Data transport networks 100 may be bridged via bridge data network nodes 104 to enable data exchange therebetween. Connected data transport networks 100 can be grouped defining areas of focus and influence for the purposes of network management and service provisioning, known as network partitions 106.

Physical links 108 provide Open Systems Interconnection (OSI) Layer-1 connectivity between data network nodes 102/104/110/120 physically conveying data for OSI Layer-2 data links between nodes 102/110/120 end-to-end. A Layer-2 data link may be provisioned over at least one physical data link 108—the sequence of physical data links 108 used representing an OSI Layer-3 path 128.

Network management and service provisioning is typically performed with the aid of at least one Network Management System (NMS) 130 connected to at least one node 102 associated with a data transport network 100.

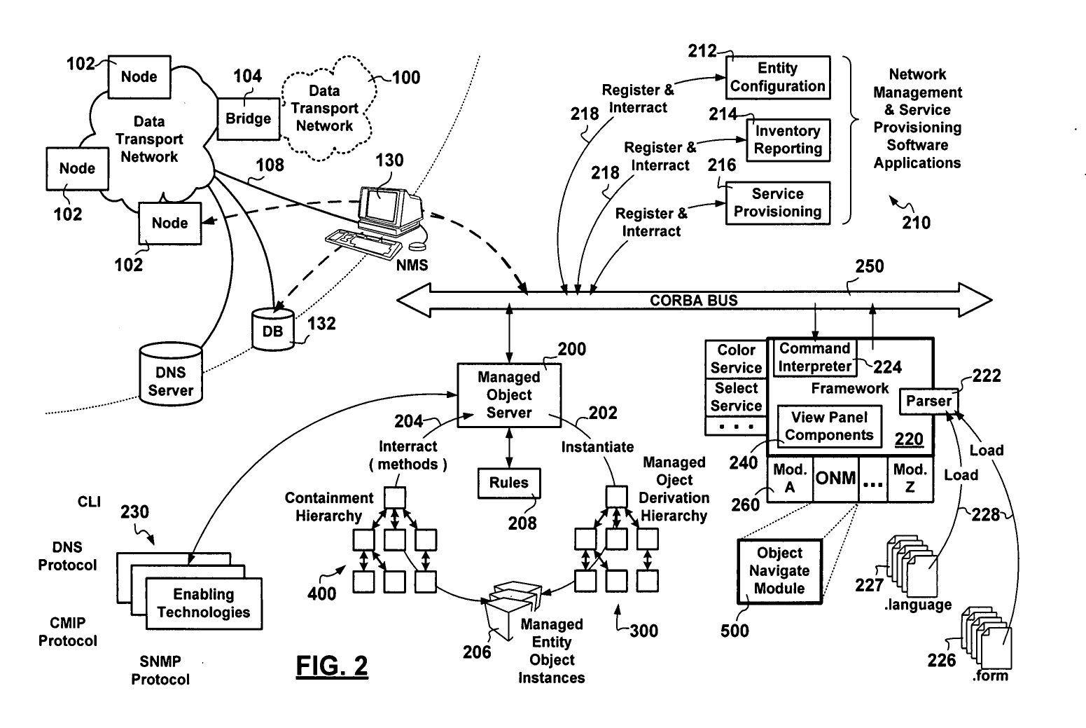

FIG. 2 is a schematic diagram showing elements implementing a network management and service provisioning solution.

In accordance with a preferred embodiment of the invention, a framework 220 is provided. The framework 220 may include a combination of hardware and software application code. The framework 220 facilitates the implementation of a software development methodology for coding complex software applications 210 relating to network management and service provisioning.

A Managed Object Server (MOS) 200 implements an architecture for providing network management and service provisioning solutions. The architecture categorizes the above presented elements into:
Manageable data network entities representative of field installed managed data network entities to be configured and controlled in providing network management and service provisioning solutions. The managed entities include:
   i. Physical data network equipment installed in the field such as: nodes 102/104, routers, switches, hubs, OC-3 links 108, etc., and
   ii. Logical data network entities associated with data network equipment installed in the field such as: network partitions 106, paths 128, virtual circuits, virtual routers etc.;
Network management and service provisioning software applications 210 used to configure and control the manageable data network entities. The software applications 210 include as mentioned above: inventory reporting 214, configuration management 212, statistics gathering, performance reporting, fault management, network surveillance, service provisioning 216, billing & accounting, security enforcement, etc.;
Network management enabling technologies 230 providing interaction with manageable entities such as logical and field installed physical managed data network entities. Enabling technologies 230 include:
   i. Data network management and service provisioning protocols: SNMP, CMIP, CLI, DNS, etc., and
   ii. Data network management and service provisioning devices: databases, DNS servers, etc.
      The interaction enabled via the MOS 200 may be command driven as specified by the software application 210, as well as event driven as a current state of the managed data transport network(s) in the realm of influence changes.

The enabling technologies 230 include support for a concept known as “persistence”. Each data network entity including data network equipment has an associated group of parameters. These parameters either have an effect on the operation of the data network entity or label the data network entity. The persistence concept encompasses the storage of, access to, reading, writing, modifying, synchronization/reconciliation, etc. of persistence parameters to control the operation of data network entities.

The persistence parameters can be stored in a network management and service provisioning database 132, as well as in registers associated with the managed physical data network equipment installed in the field. The persistence access to, reading of, writing of, modification of these parameters is provided via the data network management and service provisioning protocols mentioned above. Persistence reconciliation and synchronization is performed between a persistence database and a persistence value held in a volatile register ensuring a correct record keeping thereof, fast access to the persisted information and backup thereof. Distributed storage of persistence information is also used in reconfiguring data network equipment subsequent to network failures.

The persistence concept also encompasses special persistence types such as: constant persistence which can only be initialized but not subsequently modified or written to; as well as derived persistence which is not stored but rather calculated from other persistence values when needed.

Further information regarding persistence entity support is provided in co-pending U.S. patent application Ser. No. 10/021,080 filed on Dec. 19, 2001, entitled “NETWORK MANAGEMENT SYSTEM ARCHITECTURE” which is incorporated herein by reference.

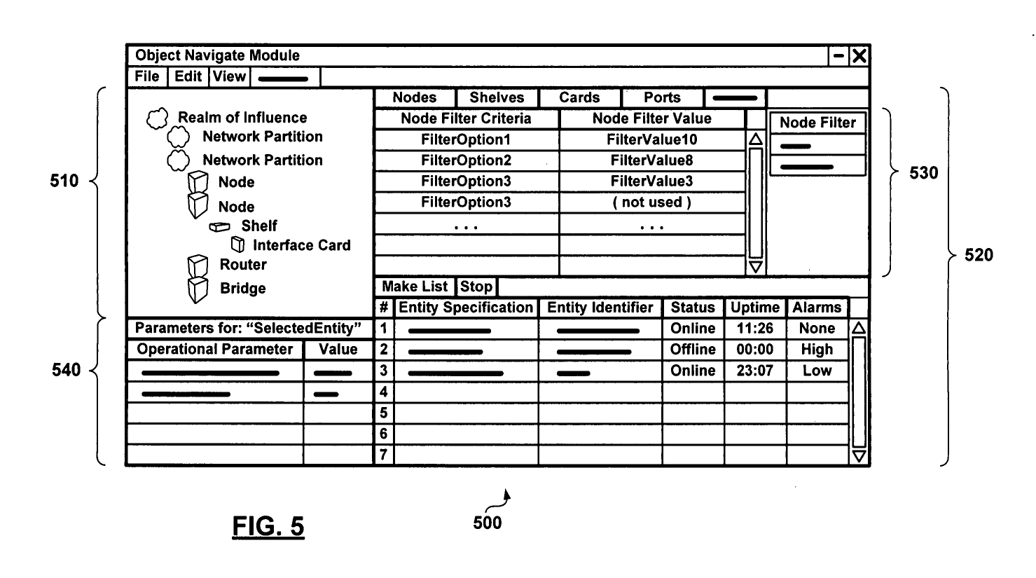

In accordance with the preferred embodiment of the invention, the framework 220 does not interact with the database 132 directly but rather via the MOS 200. The MOS 200 makes use of a managed data network entity object derivation hierarchy 300 to instantiate 202 and interact 204 with managed entity object instances 206. An exemplary managed object derivation hierarchy is presented in FIG. 3. Instantiated managed entity objects 206 form a containment hierarchy 400 an example of which is presented in FIG. 4.

In accordance with a preferred embodiment of the invention, a group of generic view panel components 240 are defined to provide support for a dynamically configurable human-machine interface. The generic view panel components 240 provide support for the display of selected context-sensitive information for inspection by the analyst as well as provides front end processing of input. The generic view panel components 240 include, but are not limited to:
an entity listing component enabling the presentation of data network entities having common characteristics;
an entity list filtering component enabling the sifting of entities listed by an entity listing component to hide unwanted listed data network entities;
an entity tree creation component presenting (hierarchical) associations and relationships between data network entities for navigation though connectivity information;
an entity parameter inspection component providing operational parameter browsing and editing—entity parameter inspection component derived view panels may also be used for data network entity context-less configuration;
an entity inclusion/creation component for instantiation of managed data network entity objects managed via the MOS 200;
an entity configuration component for changing a state of at least one data network entity in the realm of management of the network management and service provisioning solution—entity configuration component derived view panels are used for data network entity configuration subject to a context;
a validation component for interacting with the MOS 200 to validate ranges of parameters selected;
a commit component for interacting with the MOS 200 in implementing configuration changes; etc.

In accordance with the invention, the generic view panel components are instantiated, combined, and configured at run time to provide the analyst with a network management and service provisioning context specific interface for interaction therewith in performing network management and service provisioning actions. Other generic view panel components may be developed independent of or in combination with the above mentioned components to extend the functionality provided by the framework 220. For example, a further statistical information display component may be used in presenting statistical information to the analyst.

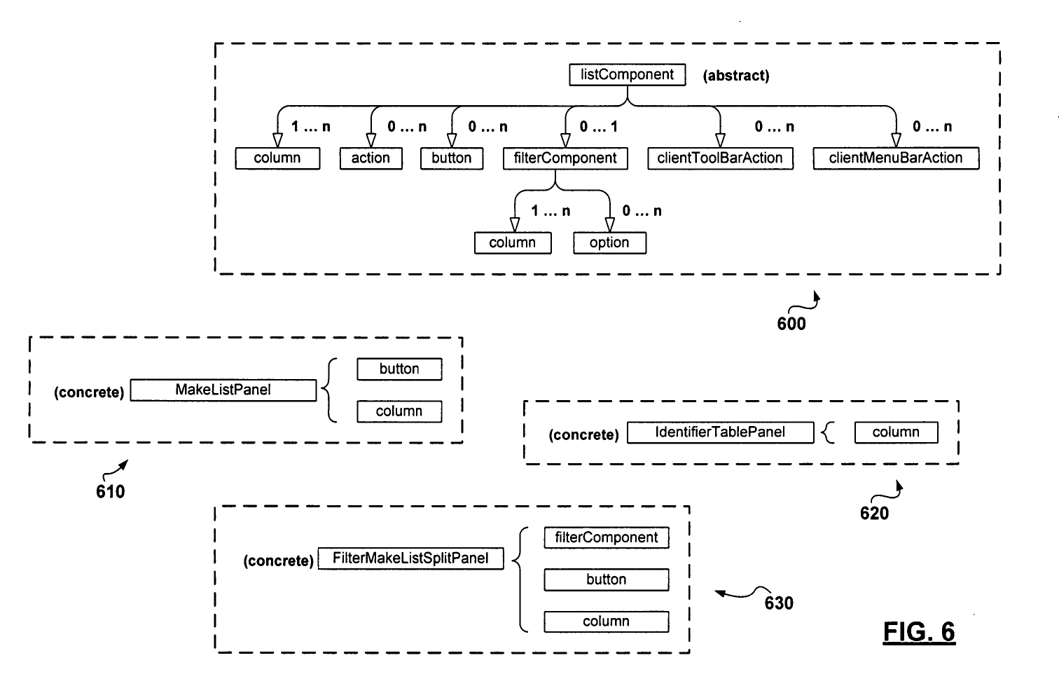

FIG. 6 shows an exemplary generic abstract implementation of a view panel component enabling entity listing in support of a dynamically configurable human-machine interface. In particular, the presented implementation of the entity listing component 600 is a combination of view panel components inheriting functionality of the entity list filtering view panel component. Concrete derived entity listing view panel components 610, 620 and 630 are also shown. FIG. 7 is a schematic diagram showing, in accordance with an exemplary implementation of the invention, a generic dynamically configurable view panel used in listing data network entities subject to filtering options in support of a dynamically configurable human-machine interface. The generic view panel shown corresponds to an instance of the entity listing view panel component 630.

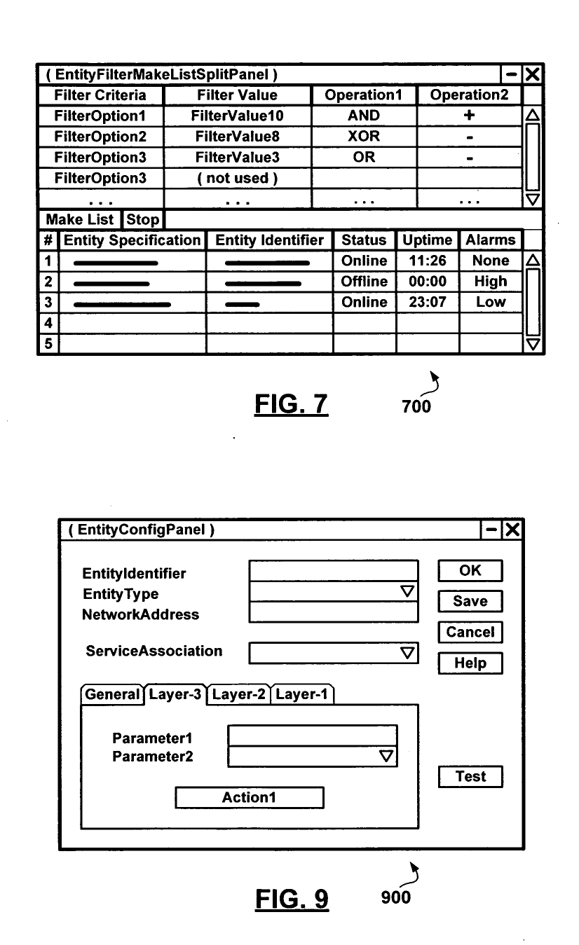

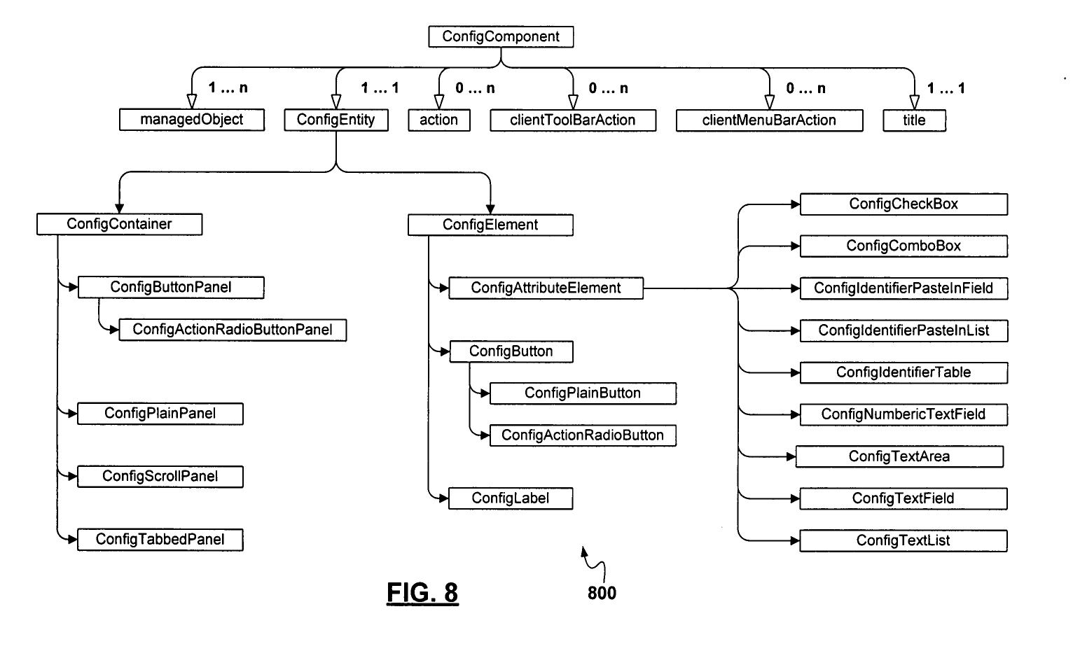

FIG. 8 is another exemplary generic abstract implementation of a view panel component enabling entity configuration in support of a dynamically configurable human-machine interface. FIG. 9 is another schematic diagram showing, in accordance with an exemplary implementation of the invention, another generic dynamically configurable view panel used in configuring data network entities in support of a dynamically configurable human-machine interface.

In accordance with the preferred embodiment of the invention, a group of run-time loadable view panel configuration description files 226, hereinafter referred to as “.form” descriptor files 226, are provided. Each one of the .form files 226 is a human-readable source code file consolidating all relevant particulars to a particular view panel used in a particular network management and service provisioning context. Each .form file 226 specifies: the look-and-feel of an associated view panel, widget attributes, etc.

In accordance with the preferred embodiment of the invention, each one of the .form files 226 may be edited at run-time and run-time re-loaded by the framework 220 to change the functionality, presentation, etc. of the associated view panel. For this purpose the framework 220 includes a .form file parser 222.

The use of the parser 222 at development, provides a troubleshooting tool for interface related issues in coding network management and service provisioning solutions without the need to re-compile and re-link edited code. After deployment, the use of the parser 222 provides for modifying and extending deployed network management and software provisioning solutions at reduced costs.

Other benefits provided by the parser 222 and the .form files 226 are realized from an improved ability to internationalize the interface presented to the analyst. The internationalization of the interface refers to the presentation of the NMS 130 interface in a written language specific to the analyst interacting with the network management and service provisioning solution. The use of the parser 222 and the .form files 226 enables the coding of the human-machine interface in a generic fashion.

In accordance with an exemplary implementation of the invention, the .form files 226 are written language specific and include labeling strings for each written language supported. Additional written languages may be supported via additional .form files 226. Although useful, this implementation require a coding engineer that is also versed in the specific language for which the language specific .form file 226 is coded.

However, in accordance with the preferred embodiment of the invention, the .form files 226 are written language independent providing run-time replaceable displayable string placeholders. Subject to a global register holding a specification of a specific written language to be used, each string placeholder is populated at run-time with displayable strings corresponding to a currently specified written language. In accordance with the preferred embodiment of the invention, displayable strings associated with a written language are provided via a run-time loadable 228 “.language” files 227.

Examples of network management and service provisioning context specific view panel specifications provided via .form files 226 include but are not limited to: create/configure/list/filter IP route, create/configure/list/filter IP link, create/configure/list/filter Label Switched Path (LSP), configure/list/filter IP router, configure/list/filter Label Switching Router (LSR), etc.

In accordance with the preferred embodiment of the invention, the parameter inspection view panel component, in combination with the list and filter view panel components, may be used to configure newly developed data network entities associated with the MOS 200 in a context-less fashion while pending development of context specific view panels. The development of context specific view panels includes the writing of at least one new .form file 226 associated with the newly developed data network entities—alternatively an existing .form file 226 can be modified.

In accordance with the an exemplary embodiment of the invention, the functionality provided by view panel components 240 presented above is further combined to define graphical user interface application modules 260. An exemplary application module 260 is an Object Navigate Module 500. An exemplary dynamically generated view panel presented to an analyst interacting with the Object Navigate Module 500 is presented in FIG. 5. The Object Navigate Module 500 combines functionality of the tree 510, list 520, filter 530 and parameter inspection 540 view panel components.

In accordance with the invention, the application modules 260 are coded in run-time loadable fashion enabling on demand loading and registration thereof with the framework 220. Additional application modules 260 may be developed, the modularity provided requires less time to develop and is relatively less susceptible to break other code when compared to prior art solutions. Therefore less regression testing is required by implementing the methods presented herein.

In operation, the analyst interacts with the NMS system 130 and in particular the analyst interacts with displayed widgets associated with instances of view panel components 240 as dynamically configured via .form files 226. Input from the analyst is packaged in the form of commands and the commands are forwarded to the framework 220. The framework 220 inspects each received command using a command interpreter 224. Upon extracting particulars specified in a command, the framework 220 makes the particulars available to the registered modules 260.

Each registered module 260 having access to the particulars of the received command, determines whether to process the received command. On determining to process the received command, each particular module 260 makes a further determination whether the processing of the received command necessitates the instantiation of view panel components. The instantiation of view panel components uses the .form files 226 to configure the view panel components and widget attributes, to display a combination of widgets having a behavior enabling the processing of the received command.

In accordance with the invention, domain logic 208 is not coded in the .form files 226 but is made available via the MOS 200. In validating and committing changes to operational parameters (the persistence support mentioned above), commands are issued by each module 260 to the MOS 200. The MOS 200 having access to the domain logic 208 specifying viable operational parameter ranges, as well as operational parameter visibility, implements changes to operational parameters.

Operational parameter visibility rules 208 are of an important mention herein because the analyst interaction is subject to a scope-of-command and a span-of-control implemented using these rules 208. On interacting with the network management and service provisioning environment, the analyst is authenticated and subsequently authorized to perform specific actions defining the scope-of-command—the actions being allowed on specific data network entities at specific times under specific conditions defining the span-of-control.

Distributed computing techniques are used in exchanging messages carrying commands between the framework 220 and the MOS 200. A Common Object Request Broker Architecture (CORBA) bus 250 is preferably used to provide support for a distributed computing environment.

The MOS 200 brokers access to connectivity information, and perhaps to statistical information, held in the database 132. The separation between the Application modules 260 and the database 132 enables an independent development of enabling technologies 230 (including independent schema development) while enabling a generic human-machine interface development. Further the use of the framework 220 and the MOS 200 provides developers with a freedom to develop Application modules 260 and associated software applications 210 without hard-coded knowledge of manageable data network entities.

In accordance with the invention, common functionality such as managed entity selection, selection lists creation and manipulation, visual labeling of selected managed entities is provided as services associated with the framework 220. The functionality of these services provided by the framework 220 transcends the functionality of modules 260 and software applications 210. As an example, these services enable the selection of data network entities via the Object Navigation Module 500 and visual labeling thereof for display on a human-machine interface associated with the service provisioning application 216.

The .form files 226 capture functionality of the specified view panels as well as a methodology used in displaying information to the analyst in a concise, efficient, context sensitive manner. An exemplary methodology is detailed in Appendix 1.

The embodiments presented are exemplary only and persons skilled in the art would appreciate that variations to the above described embodiments may be made without departing from the spirit of the invention. The scope of the invention is solely defined by the appended claims.

1. A method of providing a human machine interface for network management and service provisioning, the method comprising steps of:
a. determining an interaction context requiring an instance of a view panel to be displayed, the instance of the view panel comprising a view panel component;
b. selecting a descriptor file based on the interaction context to configure the view panel component;
c. configuring a view panel instance, the run-time configuration of the view panel instance providing dynamic configuration of the human machine interface;
d. displaying the view panel instance;
e. receiving user input; and
f. enforcing a rule defining a valid interaction with a managed object entity attribute.

2. The method claimed in claim 1, wherein the determination of the interaction context requiring the view panel instance, the method comprises a further step of: extracting particulars from a received command using a command interpreter.

3. The method claimed in claim 2, the method further comprising a step of: making the particulars of the received command available to an application module.

4. The method claimed in claim 3, wherein the application module comprises an application module registered with a graphical user interface framework for network management and service provisioning, the method further comprising the prior step of: registering the application module with the framework.

5. The method claimed in claim 1, wherein the method further comprises a step of accepting input.

6. The method claimed in claim 5, wherein the method further comprises a step of validating input.

7. The method claimed in claim 5, wherein the method further comprises a step of committing configuration changes to managed network entity attributes.

8. The method claimed in claim 1, wherein the method further comprises steps of: exchanging a message with a managed object server.

9. The method claimed in claim 8, wherein exchanging the message with the managed object server, the method further comprises a step of: encapsulating a command in the message.

10. The method claimed in claim 8, wherein exchanging the message with the managed object server, the method further comprises a step of: decapsulating a command from a received message.

11. The method claimed in claim 10, wherein the determination of the interaction context further comprises a step of: interpreting the received command.

12. The method claimed in claim 1, wherein configuring the instantiated view panel, the method further comprises a step of: combining at least two view panel components in instantiating the view panel.

13. The method claimed in claim 1, further comprising a step of parsing the descriptor file at run-time in configuring the view panel instance.
